(19) United States
(12) Patent Application Publication
(10) Pub. No.: US 2010/0296834 A1
(43) Pub. Date: Nov. 25, 2010

(54) DISPERSED TONER REMOVING METHOD AND IMAGE FORMING APPARATUS

(75) Inventor: Yuichi OMORI, Hachioji-shi (JP)

Correspondence Address: CANTOR COLBURN LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/778,397

(22) Filed: May 12, 2010

(30) Foreign Application Priority Data
May 19, 2009 (JP) 2009-120680

(51) Int. Cl. G03G 21/00

(52) U.S. Cl. 399/99

(57) ABSTRACT

In a dispersed toner removing method, a suction port of a suction duct is provided close to a developer carrying body, and a suction device is provided downstream of a suction route of the suction duct with a toner collecting device between the suction device and the suction duct. The dispersed toner at the development area is sucked and removed by the operation of the suction device during the process of development. The control factor related to toner dispersion amount is monitored, and the suction force of the suction duct is modified based on the result of monitoring of the control factor.

This application is based on Japanese Patent Application No. 2009-120680 filed on May 19, 2009 with Japanese Patent Office, the entire content of which is hereby incorporated by reference.

### BACKGROUND OF THE INVENTION

The present invention relates to a dispersed toner removing method in an image forming apparatus such as a photocopier, printer and facsimile machine, and an image forming apparatus capable of implementing this dispersed toner removing method.

For example, in one of the conventionally known image forming apparatuses, the surface of the photoreceptor drum as a charge holder is subjected to the processing of charging and exposure to create an electrostatic latent image which is developed to produce a toner image. The toner image is then directly transferred to a transfer material or is transferred to the transfer material after having been transferred to an intermediate transfer member, whereby heating and fixing operations are performed.

In such an image forming apparatus using electrophotographic process, the development apparatus as a developing device includes, as major components, a rotatable developer carrying body made of a sleeve, and a plurality of magnets provided at fixed positions inside the developer carrying body. As the developer, a two-component developer comprising a carrier made of magnetic particles, and nonmagnetic toner is used over a wide range.

In the development process, the developer carrying body is rotated, and the developer attracted and held onto the surface of this developer carrying body by the magnetic operation is fed to the development area from a prescribed position. The development process takes place in a contact or contactless manner under the presence of an electric field formed between a photoreceptor drum and developer carrying body.

In the conventional image forming apparatus having the aforementioned development apparatus, toner dispersion in the process of development cannot be avoided, with the result that the interior of the image forming apparatus is contaminated. To meet the requirements of higher image quality, efforts have been made to minimize the toner particle size. These efforts lead to an increase in toner dispersion.

Several technological proposals have been made to reduce the damages given by dispersed toner. According to one of these proposals, in a color image forming apparatus, the suction capacities of a plurality of suction ducts are adjusted to ensure uniform suction of dispersed toner in the longitudinal direction of the developer carrying body. To put it more specifically, the length of the duct opening is made approximately the same as the length of the developer carrying body in the longitudinal direction, and the smallest sectional areas of the suction ducts are made different for each of suction ducts, whereby suction capacity of each development apparatus is adjusted (Japanese Patent Application Publication No. 2007-140038).

In another proposed technique, dispersed toner suction ports are provided on the outside of the magnetized area of the developer carrying body, thereby preventing toner from dispersing through the portion close to both ends of the developer carrying body (Japanese Patent Application Publication No. 2006-106557).

The techniques disclosed in the Japanese Patent Application Publication No. 2007-140038 and Japanese Patent Application Publication No. 2006-106557 are useful in their own way, but there is room for further improvement. For example, in the method disclosed in the Japanese Patent Application Publication No. 2007-140038, the suction capacity of each suction duct is determined in proportion to the amount of dispersed toner in each development apparatus. To put it another way, toner dispersion may occur if there is a change in the amount of dispersed toner according to the time of using the development apparatus. If, for example, the suction force has been adjusted to the level conforming to the greater amount of toner dispersion, excessive suction is caused when there is a reduction in the amount of dispersion. This will destroy the balance, with the result that toner will spill.

The aforementioned two Patent Literatures fail to propose a technique of removing the dispersed toner in conformity to possible changes in the amount of dispersed toner that may be caused by varying conditions.

In view of the problems described above, it is a main object of the present invention to provide a dispersed toner removing method capable of effective suction and removal of dispersed toner by modifying the suction force of a suction duct in conformity to changes in the amount of toner dispersion using a simple structure. Another object of the present invention is to provide an image forming apparatus capable of implementing the aforementioned dispersed toner removing method.

### SUMMARY

An object of the present invention can be achieved by the following structures.

(A) A dispersed toner removing method for inhaling and removing a dispersed toner occurring in a development area, by forming a suction port of a suction duct in a vicinity of a developer carrying body, and by installing a suction device in a downstream position of a suction route of the suction duct, a toner collecting device being provided between the suction device and the suction duct, and then by operating the suction device at a time of a development process, the dispersed toner removing method including the steps of:

monitoring a control factor relating to a toner dispersion amount; and

changing a suction force of the suction duct based on a result of the monitoring of the control factor.

(B) An image forming apparatus including: an image carrying body;

a developing device for developing an electrostatic latent image formed on the image carrying body, by conveying a developer to a development area by a developer carrying body;

a suction duct having a suction port in a vicinity of the developing device;

a suction device installed in a downstream position of a suction route of the suction duct, with a toner collecting device being provided between the suction device and the suction duct; and

a control device which monitors a control factor relating to toner dispersion, and changes and controls a suction force of the suction duct based on a result of the monitoring of the control factor.

### BRIEF DESCRIPTION OF THE DRAWINGS

FIG. 1 is a schematic diagram representing the structure of an image forming apparatus composed of a digital color photocopier.

FIG. 2 is a schematic diagram representing the relationship between changes in the charge mount relative to the period of use of the carrier and the suction force of the suction duct conforming to these changes.

FIG. 3 is a flow chart showing the control process in the present invention.

FIG. 4 is a schematic diagram representing the relationship between changes in the charge amount of the developer when the relative humidity has been changed and the suction force of the suction duct conforming to these changes.

FIG. 5 is a diagram showing the output condition of the suction device (suction fan) with respect to the relative humidity.

FIG. 6 is a diagram showing the output condition of the suction device with respect to the amount of toner supplied according to the print rate of unit number of prints.

FIG. 7 is a side view representing the structure of a development apparatus and the relationship between the development apparatus and suction duct.

FIG. 8 is an explanatory diagram showing the relationship of the suction apparatus including the suction duct and the second suction duct in the present embodiment.

FIG. 9 is a schematic diagram of the partial cross section showing the communicating port of FIG. 8.

### DETAILED DESCRIPTION OF THE PREFERRED EMBODIMENT

The following describes the other preferred embodiments of the present invention.

1. The dispersed toner removing method described in the aforementioned (A) wherein the control factor is a period of use of a carrier which is made of magnetic particles, with the magnetic particles and a toner constituting a developer.

2. The dispersed toner removing method described in the aforementioned (A) wherein the control factor is an ambient relative humidity.

3. The dispersed toner removing method described in the aforementioned (A) wherein the control factor is a print rate of unit number of prints relating to an amount of a supplied toner per unit number of prints.

4. The image forming apparatus described in the aforementioned (B) wherein the developing device is installed detachably and reattachably on a frame for holding the image carrying body, and apart of the suction duct is formed on the frame.

The following describes the embodiments of the present invention with reference to the drawings. However, the present invention is not limited to these.

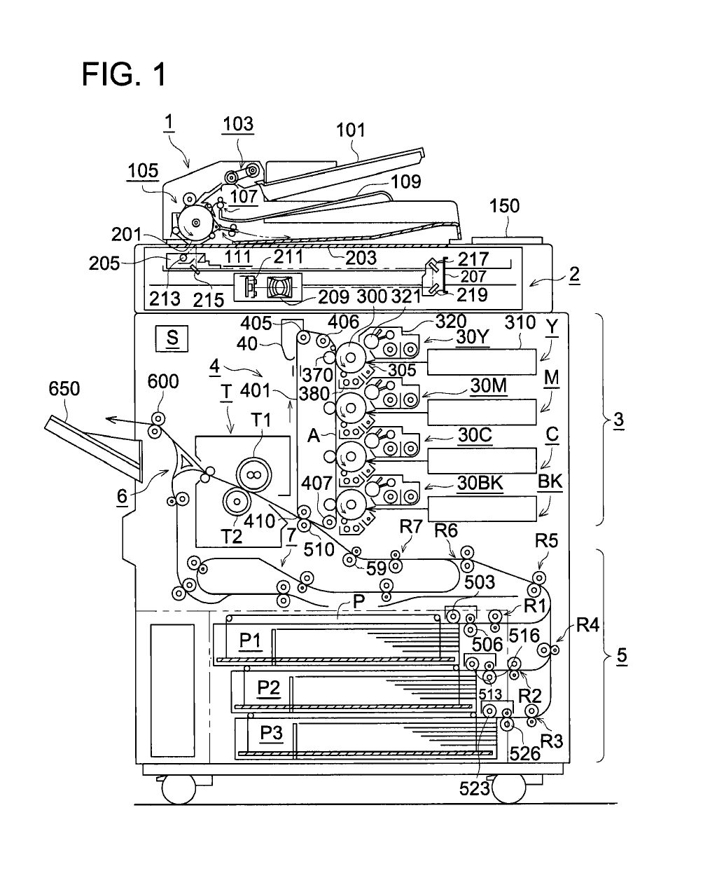

FIG. 1 is a schematic view representing the structure of an image forming apparatus made up of a digital color photocopier.

The image forming apparatus of FIG. 1 has a automatic document feed apparatus 1 provided on the top of the apparatus main body, and incorporates an image reading section 2, an image forming section 3, a belt installation section for the belt unit 4, a sheet feed section 5, a fixing apparatus T, a sheet reverse ejection/re-feed section 6, and a reverse conveyance device 7.

The automatic document feed apparatus 1 includes a document placement table 101, a document separation device 103, a document conveyance section 105, a document ejection device 107, a document ejection stand 109, and a document reversing device 111 made up of a pair of rollers for reversing the documents in the duplex copying mode.

The document reading position is arranged below the document conveyance section 105, and a document image is read through the slit 201 constituting the image reading section 2. Then the documents having been read are ejected onto the document ejection stand 109 by the document ejection device 107. After one side of the document has been read in the duplex copying mode, the document is conveyed in the direction marked by the arrow of a two-dot chain line by the document reversing device 111.

The document is again led to the image reading position through the document conveyance section 105 by the reverse rotation of the document reversing device 111 after the drive has been suspended in the state of sandwiching the trailing end of the document in the direction of travel. After that, the document is ejected onto the document ejection stand 109 by the document ejection device 107.

The image reading section 2 includes a slit 201, a first mirror unit 205 integrally made up of a document irradiation lamp 213 and a first mirror 215 for reflecting the light reflected from the document, and a second mirror unit 207 integrally formed of a second mirror 217 and third mirror 219.

The image reading section 2 also includes an imaging lens 209 for ensuring that the light reflected from the third mirror 219 is imaged on the image pickup element, and a linear image pickup element (hereinafter referred to as “CCD”) 211 for obtaining image information by photoelectric conversion of the optical image formed by the imaging lens 209. After having been subjected to approximate image processing, the image information is stored in the memory in a control section S to be described later.

When the document fed by the automatic document feed apparatus 1 is read by the image reading section 2, the first mirror unit 205 and second mirror unit 207 are fixed at the illustrated position.

The image information for each color read by the image reading section 2 and subjected to image processing is sequentially read from the aforementioned memory and is inputted as an electric signal into the exposure optical system as an electrostatic latent image formation device for each color.

The image forming section 3 has four image forming devices 30 (30Y, 30M, 30C and 30BK: hereinafter referred to as “image forming unit”) of Y (yellow), M (magenta), C (Cyan), and BK (Black) colors forming the toner image in conformity to the color-decomposed image.

Each of the image forming units 30 includes major components such as a photoreceptor drum 300 as an image carrying body, a charging device 305, an exposure optical system 310 as an image writing device, a development apparatus 340 as a developing device, transfer device 370, and a cleaning device 380. The exposure optical system 310 is an exposure unit made up of a laser optical system. In the drawing, reference numerals are only assigned to the members constituting the yellow image forming unit. However, other image forming units are designed in a basically the same structure.

The development apparatus 320 stores a two-component developer containing a carrier composed of magnetic particles and a non-magnetic toner, and the developer is conveyed to development area by the developer carrying body (hereinafter referred to as a development sleeve for the sake of convenience) 321.

Inside the development sleeve, magnets are arranged at fixed positions and the developer is held on the surface of the rotatable development sleeve with the influence of the magnets and then conveyed from a prescribed position in the development apparatus to the development area. Since this structure is basically well known, the detailed description is omitted.

At the lower position of the development apparatus 320, a suction duct relating to the present invention is provided for removing a dispersed toner and it has a structure for removing a dispersed toner generated during operating time of the development apparatus. The details will be described later.

The image forming units 30 are arranged in the order of yellow (Y), magenta (M), cyan (C) and black (BK) from the top, along the traveling direction of one plane (tightened surface) A of the loop-shaped intermediate transfer belt 401 constituting the belt unit 4, provided in the vertical direction. The belt unit 4 is composed of the intermediate transfer belt 401, supporting rollers 405, 406, and 407 for rotatably supporting the intermediate transfer belt, and a backup roller 410.

The secondary transfer device is composed of the backup roller 410 and rotatable transfer roller 510 which is arranged in the opposed position while sandwiching the intermediate transfer belt 401.

The following describes image formation using the aforementioned construction of the image forming unit 30 and belt unit 4.

The surface of the photoreceptor drum 300 rotating in the counterclockwise direction at the start of the image forming process is charged to have a predetermined polarity (negative polarity in this case) by the charging device 305. Exposure corresponding to the first color signal by the exposure optical system 310, i.e., the yellow (Y) image signal is provided, and the electrostatic (charge) latent image corresponding to the yellow (Y) image is formed on the photoreceptor drum 300. The electrostatic latent image is subjected to reverse development by the development apparatus 320, and is converted into the yellow (Y) toner image. After that, the image is transferred onto the intermediate transfer belt 401 by the function of the transfer device 370.

Image formation by other color signals which is started sequentially at a predetermined time subsequent to the initiation of image formation by the first color signal is performed by each of the image forming units 30 of magenta (M), cyan (C), and black (BK) according to the same process as the above. The toner images on the photoreceptor drum formed by respective image forming units are sequentially transferred to be superimposed with the image region containing the yellow (Y) toner image, whereby a superimposed color toner image is formed on the intermediate transfer belt 401.

The surface of the photoreceptor drum 300 subsequent to the transfer processing is cleaned by a cleaning device 380, whereby preparation is made for formation of a new image.

During the abovementioned development processing, dispersed toner generated around the opening section of development apparatus 320 opposed to the photoreceptor drum 310 is inhaled and removed through a suction duct to be described later and then collected by a toner collecting device.

The reference numeral S signifies the control device (hereinafter referred to as “control section”) including a computer. This control section incorporates a machine operation program, and provides all forms of control, including the control relating to a series of image forming processes, the control of the sheet feed, and change of the suction force of the suction duct pertaining to the development apparatus.

To put it another way, the control section S includes a CPU for computation control processing, a ROM storing various forms of operation programs, and a RAM storing the data on the results of computation. The outputs of various types of sensors are inputted into the CPU through the interface, and the drive of the motor or display section is controlled based on the information.

The reference numerals P1, P2, and P3 indicate sheet storage sections which store a transfer material (hereinafter refer to as a sheet) P, and the structures of them are basically identical.

The feed-out section of the sheet storage section (P1 through P3) is provided with sheet feed rollers 503, 513, and 523, separation rollers 506, 516, and 526, and conveyance rollers R1, R2, and R3. The sheets P fed out are conveyed along the sheet conveyance path provided with conveyance rollers R4 through R7.

The reference numeral 59 denotes a registration roller, which is installed close to the secondary transfer section on the downstream side of the conveyance roller R7. A fixing apparatus T is installed downstream from the secondary transfer section (wherein a transfer roller 510 is located). The major components of the fixing apparatus T include the first fixing roller T1 incorporating a heating source, and the second fixing roller T2 rotating in close contact with the first fixing roller.

The reference numeral 600 denotes a sheet ejection roller, and 650 indicates a sheet ejection tray for stacking and storing the sheets having been ejected. The form or conveyance control of the sheet conveyance path of the sheet reverse ejection/re-feed section 6, and the reverse conveyance device 7 is commonly known and is not directly related to the present invention. Accordingly, the description thereof is omitted.

The following briefly describes the processes wherein the color toner image formed on the intermediate transfer belt 401 is transferred onto the sheet, and the sheet is ejected out of the apparatus.

The sheet P is fed by the sheet feed roller 503, for example, at an appropriate timing conforming to the formation of an image on the intermediate transfer belt 401. Then the sheet P is sandwiched and conveyed by the separation roller 506, and a plurality of conveyance rollers R1 through R7 arranged along the conveyance path, and is fed toward the registration roller 59 arranged in front of the transfer section. The sheet P to be fed is designated and selected on the operation display plate 150 on which the number of sheets to be recorded, recording start, magnification rate for recording, or image density can be set.

After the leading edge of the sheet P has come in contact with the registration roller 59, the sheet P is re-fed by the restart of rotation of the registration roller 59 so as to superpose the sheet P on the color toner image region on the intermediate transfer belt 401. Then, the sheet P together with the intermediate transfer belt is sandwiched and pressed between the backup roller 410 and transfer roller 510 in the secondary transfer section. During this time, the color toner image on the intermediate transfer belt 401 is transferred onto the sheet P.

The sheet P with the toner image having been transferred thereon is separated from the intermediate transfer belt 401, and is conveyed toward the fixing apparatus T by the conveyance belt (not illustrated). The sheet P is heated and pressed, whereby toner is molten and is fixed on the sheet P and the sheet P is conveyed to the sheet ejection roller 600, and is ejected onto the sheet ejection tray 650.

After completion of the secondary transfer, the surface of the intermediate transfer belt 401 is cleaned by the cleaning device 40 and is made ready to carry a new toner image.

As described above, toner dispersion occurs in the aforementioned image forming apparatus. The present inventors have conducted a great number of tests to verify that the status of the toner dispersion (amount of dispersed toner) is changed by specific factors.

Specific factors include the period of use of the carrier (synonymous with the period of use of developer), ambient relative humidity, and the print rate of unit number of prints related to the amount of the supplied toner per unit number of prints. The following describes these specific factors and changes in toner dispersion amount (the amount of dispersed toner). In the following description, the aforementioned specific factors will be called “control factors” since they are bases of control in the present invention for effective suction and removal of dispersed toner.

(1) The period of use of carrier as a control factor, toner dispersion and modification of suction force

A new developer including the carrier made up of magnetic particles and non-magnetic toner powder exhibits a gradual deterioration from the initial phase of the period of use, toward the end of life, and the amount of dispersed toner changes accordingly. To put it more specifically, for example, to meet the requirements of providing the toner with the amount of charge required for development process, the developer is fed in a prescribed direction while being agitated by an agitating device inside the development apparatus. However, the carrier is subjected to deterioration with the lapse of time of using the development apparatus. The amount of charge is reduced in the deteriorated carrier, whereby force of connection with toner is reduced. Thus, the toner in the developer carried on the development sleeve by the magnetic force is easily removed by rotation of the development sleeve, with the result that the amount of dispersed toner tends to exhibit a gradual increase.

In the present invention, a test is conducted to obtain the relationship between the period of use of carrier and toner dispersion amount. Control is provided to increase the suction force of the suction duct conforming to the increase in the amount of dispersed toner. To put it another way, the suction force of the suction duct is basically expressed by F1>F2 wherein F1 denotes the suction force for a higher amount of toner dispersion and F2 denotes the suction force for a lower amount of toner dispersion. As described above, when the control factor is the period of use of carrier (the same goes for developer), a change is made to satisfy F_{E}>F_{B}, wherein F_{B} indicates the suction force of the suction duct in the initial period of carrier use, and F_{E} denotes the suction force of the suction duct when the period of use of carrier represents the end of life.

The period of use of carrier as the control factor is monitored by the control device S (FIG. 1). The control device S provides control so that the suction force of the suction duct is modified, when the period of use has reached time (prescribed condition) which has been preset (stored in the control device S). The modification in suction force can be performed by changing the size of the opening of the suction duct by means of a shielding member, for example.

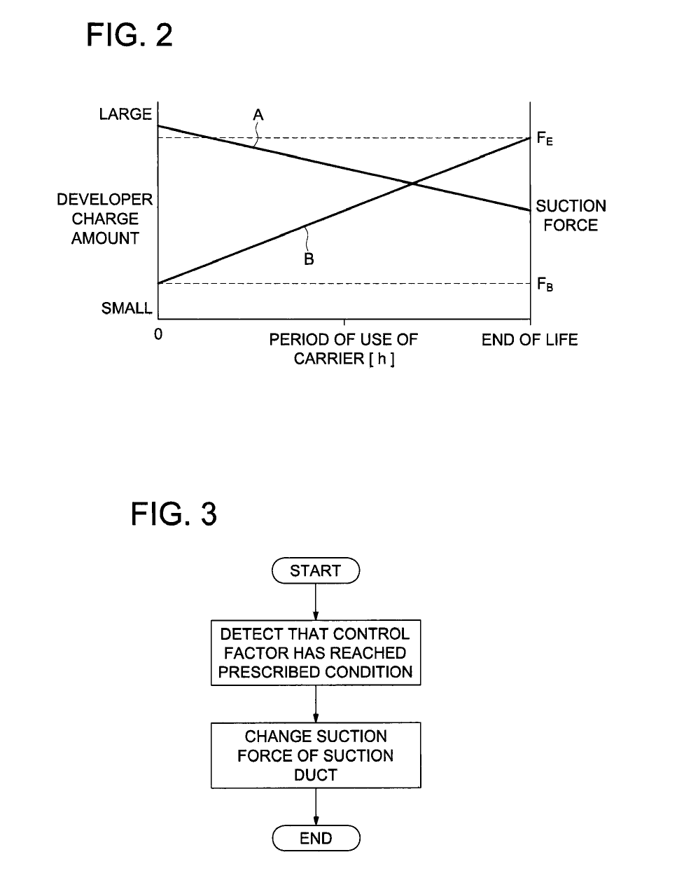

FIG. 2 is a schematic diagram representing the relationship between changes in the mount of charge according to the period of use of carrier and the suction force of the suction duct conforming to these changes. In FIG. 2, line (A) shows changes in the charge amount of the developer (synonymous with carrier), and line (B) indicates the suction force of the suction duct. Similarly, FIG. 3 is a flow chart showing the control process relating to the present invention, including the aforementioned control.

In the description of the aforementioned embodiment, it is described that a modification of the suction force accompanying the period of use of carrier occurs once during the transition from the initial period of use to the end of life. This does not preclude the embodiment wherein control is provided based on the time appropriately subdivided according to the degree of changes in the amount of dispersed toner.

In the image forming apparatus of FIG. 1, when each development apparatus is provided with an independent suction apparatus (such as a suction duct and suction device), the suction force of the suction duct is variable in conformance to each period of use of developer. Further, when the suction apparatuses are integrated into one unit so as to include a common suction duct section connected with suction ducts corresponding to each of a plurality of development apparatuses and a common suction device, the suction force is adjusted to the level conforming to the development apparatus wherein the period of use of developer is the longest.

(2) A change in ambient relative humidity as a control factor, toner dispersion amount, and modification in suction force

In the developer including the carrier made of magnetic particles and nonmagnetic toner powder, the binding force between toner and carrier is reduced by reduction in the developer charge amount when it is highly humid, similarly to the case of the aforementioned (1). This results in an increase of toner dispersion amount during the rotation of the development sleeve. When it is less humid, developer charge amount is increased over that when it is highly humid. This results in reduced toner dispersion amount. In the present invention where the suction force of the suction duct is modified in conformity to this phenomenon, for example, a humidity detecting sensor is installed in the vicinity of the development apparatus so that the humidity change is monitored by the control device S. When the relative humidity has reached the preset humidity (prescribed condition), the suction force of the suction duct is controlled and modified through the control device S.

As described above, when the ambient relative humidity is the control factor, for example, modification is made so as to satisfy F_{H}>F_{L} wherein F_{H} indicates the suction force of the suction duct when the ambient relative humidity is high, and F_{L} denotes the suction force of the suction duct when the ambient relative humidity is lower than that.

Conditions (a plurality of divisions) for modifying the suction force can be determined by a test conducted to verify the relationship between the change in relative humidity and toner dispersion amount. This is stored in the control device S. The suction force can be modified, for example, by changing the size of the suction duct opening with a shielding member.

In the present embodiment, control is provided in such a way that the suction force is increased in a highly humid environment (70% RH or more) and is reduced in a less humid environment (less than 30% RH). In the intermediate humidity environment (30% RH through 70% RH), the suction force is modified in several steps in conformance to the relative humidity.

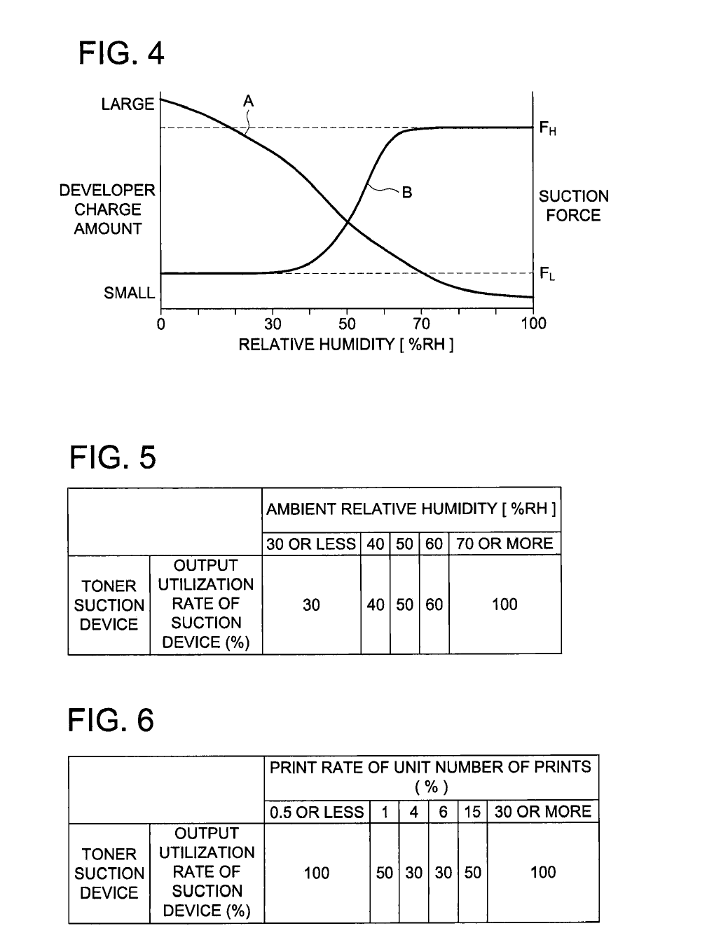

FIG. 4 is a schematic diagram representing the relationship between changes in the amount of the charge of the developer and the suction force of the suction duct conforming to these changes when the relative humidity has been changed as explained above. In FIG. 4, line (A) indicates a change in the charge amount of the developer and line (B) represents the suction force of the suction duct. Similarly, FIG. 5 shows the output status of the suction device (suction fan) with respect to the relative humidity described above.

In the above description, when the suction force is subjected to an abrupt change in response to the abrupt change of humidity, the balance of air volume with respect to toner dispersion may be destroyed. Thus, the humidity value used for modification control is preferably the average humidity per unit time. The unit time can be determined as appropriate.

(3) Print rate of unit number of prints related to the amount of supplied toner per unit number of prints as a control factor, toner dispersion amount, and modification of suction force

The development apparatus using the developer including the carrier made of magnetic particles and the nonmagnetic toner powder is provided with a toner density detecting sensor that uses the output signal to ensure that the same amount of toner as a toner which has been consumed in the process of development is supplied at an appropriate time and a constant amount of toner is maintained in the developer.

In the meantime, a formed image can be classified into a high print rate image and a low print rate image. For example, if high print rate images are formed on a continuous basis, there will be an increase in the amount of consumed toner and in the supplied toner. Toner is carried by the development sleeve and is conveyed to the development area while the charge amount of the developer provided by the agitation device inside the development apparatus is insufficient. This will result in an increased amount of dispersed toner. Further, if low print rate images are formed on a continuous basis, the toner not used in the development remains on the development sleeve, and the charge amount will be reduced, with the result that the amount of dispersed toner is increased.

In the present invention wherein the suction force of the suction duct is modified in conformity to such a phenomenon, for example, the suction force conforming to this print rate is obtained from the table set in advance and calculation of the print rate for one page calculated by the control device S, and the suction force of the suction duct is modified according to the result.

In the present embodiment, as described above, if the control factor is the amount of the supplied toner conforming to the print rate of unit number of prints, modification is performed so as to satisfy F_{X}>F_{Y} wherein F_{X} indicates the suction force of the suction duct when the print rate is high or low, and F_{Y} denotes the suction force of the suction duct when the print rate is intermediate. The conditions (a plurality of divisions) for modifying the suction force can be determined by a test conducted to verify the relationship between the amount of the supplied toner conforming to the print rate of unit number of prints and the amount of dispersed toner. They are formulated in a table and stored in the control device S. The suction force can be modified by changing the size of the suction duct opening with a shielding member.

As described above, the print rate and others as control factors are monitored by the control device S (FIG. 1). When the print rate and others have reached the preset print rate (prescribed condition), the suction force of the suction duct is controlled and modified through the control device S.

FIG. 6 is a diagram showing the output status of the suction device with respect to the print rate of unit number of prints (practically, the amount of toner supplied according to the print rate). In the present embodiment, when the print rate is low (e.g., 0.5% or less) and the print rate is high (e.g., 30% or more), 100% of the suction device output can be used. A further subdivision was made at the print rate intermediate between them, and the suction force was modified in response to the division.

The print rate of unit number of prints refers to the average print rate (percentage) of 1,000 prints immediately before the relevant job, without the present invention being restricted thereto. The suction force is not subjected to an abrupt change in response to the abrupt change of this print rate, and hence this has the effect of making the suction force variable while the balance of air volume with respect to toner dispersion is not destroyed. However, the suction force can be changed and controlled according to the division conforming to the print rate of each page, if there is no substantial impact on the suction and removal of the dispersed toner even when the suction force is subjected to an abrupt change.

In the image forming apparatus of FIG. 1, when each development apparatus is provided with an independent suction apparatus (such as a suction duct and suction device), the suction force of the suction duct is changed and controlled in response to the print rate of each development apparatus. Further, when the suction apparatuses are integrated into one unit so as to include a common suction duct section connected with suction ducts corresponding to each of a plurality of development apparatuses and a common suction device, the suction force is preferably adjusted to the level conforming to the development apparatus wherein the toner dispersion is the highest.

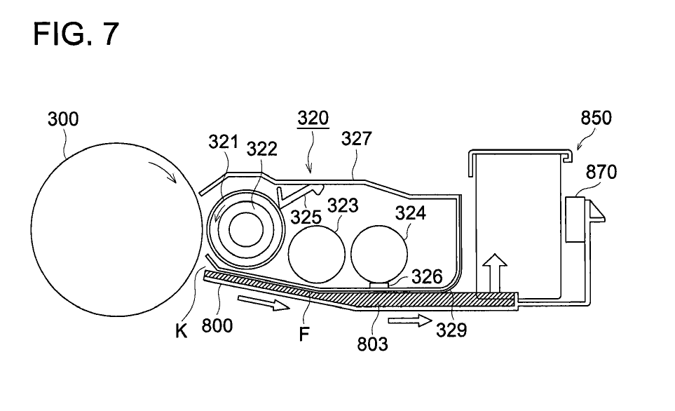

The following describes the mechanical structure relating to the present invention. FIG. 7 is a side view representing the structure of a development apparatus and the relationship between the development apparatus and suction duct.

In FIG. 7, the development apparatus 320 includes a developer carrying body made up of the development sleeve 321 arranged opposed to the photoreceptor drum 300, and a rotatable developer agitating conveyance members (hereinafter abbreviated as “agitating members”) 323 and 324 which are provided behind the development sleeve 321 and in parallel with the development sleeve.

The reference numeral 322 indicates a magnet, which is installed at a fixed position inside the development sleeve 321. This magnet allows the developer to be magnetically attracted onto the peripheral surface of the rotating development sleeve 321. Further, the developer having passed through the development area can be removed from the peripheral surface of the development sleeve 321 by the repulsive magnetic field. The reference numeral 325 is a blade for regulating the thickness of the developer layer on the development sleeve 321. The reference numeral 326 is a toner density detecting sensor, which is provided on the lower side of the agitating member 324 and on the furthest side in FIG. 7.

In the operation of the development apparatus, the agitating members 323 and 324 allow the stored developer to be circulated, and provides toner with a prescribed charge amount during the circulation. For example, the agitating member 324 agitates and conveys the developer from the near side to the far side on FIG. 7, and supplies the developer to the flow path in which the agitating member 323 is provided on the furthest side. The agitating member 323 agitates and conveys the developer from the far side to the near side on FIG. 7, Halfway through this process, the developer is attracted onto the development sleeve 321, and is consumed for development. Prior to this process, the developer is attracted onto the development sleeve and passes through the development area. After that, the developer is removed from the development sleeve and is conveyed as it is captured by the developer being agitated and conveyed by the agitating member 323. To put it another way, the agitating member 323 agitates and conveys the developer while replacing the developer on the development sleeve 321. On the nearest end, the agitating member 323 supplies the developer again to the flow path provided with the agitating member 324. This procedure is repeated during the operation of the development apparatus. Each of the agitating members 323 and 324 can be manufactured in the shape of a screw.

A toner supply inlet is formed on the corresponding cover 327 above the agitating member 323 or 324 on the near side end of FIG. 7. The developer conveyed in the state of being agitated and mixed with the supplied toner is detected by the toner density detecting sensor 326, and the output is captured by the control device S whenever necessary, and is used for further toner supply control.

The hatched section shown below the bottom wall 329 of the development apparatus is a suction duct (suction passage) 803 that sucks and removes the toner dispersed close to the development area. The reference symbol K indicates the suction port of the suction duct. In the traveling direction of the removed dispersed toner in the present application, the side of the suction port will be referred to as the upstream side (upstream position) of the suction mute, while the side of the suction device (to be described later) will be called the downstream side (downstream position) of the suction route.

The white arrow indicates the traveling direction of the air produced by the operation of the suction device (to be described later). The reference numeral 850 is a second suction duct connected to the rear end of the suction duct 803. The reference numeral 870 represents the humidity detecting sensor located close to the back of the development apparatus 320.

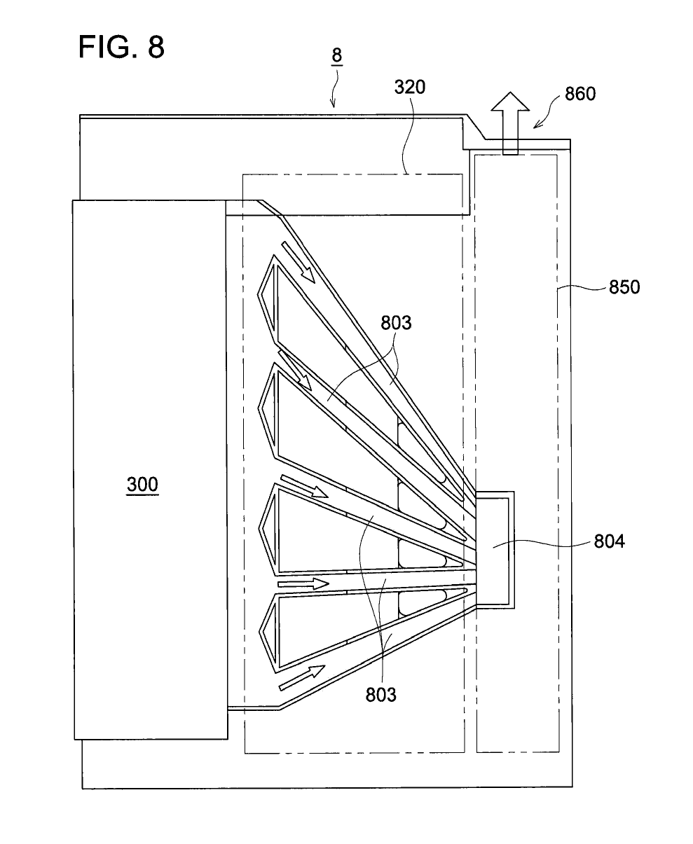

Referring to FIG. 8, the following provides the supplementary description based on the structure of FIG. 7. FIG. 8 is a plan view of FIG. 7 showing the relationship of the suction apparatus including the suction duct and the second suction duct in the present embodiment. The aforementioned suction duct 803 includes a plurality of trenched formed on the bottom wall 800 of the drum frame 8 holding the photoreceptor drum 300, and a film F covering the open portion above the trenches. The width of the suction port K of the suction duct 803 has a width for covering the area slightly greater than the magnetized area in the longitudinal direction of the development sleeve 321, for example. The rear end is connected with the communicating port 804 which is less wide and contains a rising part. The communicating port 804 is connected with the second suction duct 850 extending on the drum frame 8 in the longitudinal direction of the development apparatus 320. The second suction duct 850 is connected, through the air emission connection port 860, with the third suction duct (not illustrated) containing a porous toner collecting device (not illustrated) and a suction device such as a sirocco fan located downstream thereof. The third suction duct communicates with the external portion of the image forming apparatus. The development apparatus 320 is installed detachably and reattachably on the drum frame 8.

The toner collecting device can be manufactured, for example, by forming a filter or filter material into a box-like shape. In this structure, the dispersed toner generated close to the development area is led into the suction route made of a suction duct 803 by the air flow resulting from the operation of the suction device and is collected into the toner collecting device through the suction route formed by the second and third suction duct. This development apparatus 320 is held on the upper surface of the bottom wall 800 which is not forming a suction duct, and is kept at the prescribed position by an appropriate locking device.

In the above description, the suction mute for removing toner is made of three suction ducts, and a plurality of suction ducts 803 are provided. It should be noted that the present invention is not restricted thereto. Further, in the above description, it is assumed that the aforementioned suction duct, toner collecting device, and the suction apparatus including the suction device are provided for each of the development apparatuses. However, when the image forming apparatus has a plurality of development apparatuses, it is also possible to make such arrangements that one end of the suction duct corresponding to each of the development apparatuses is connected to the common suction duct, and toner collecting device and suction device are used in common.

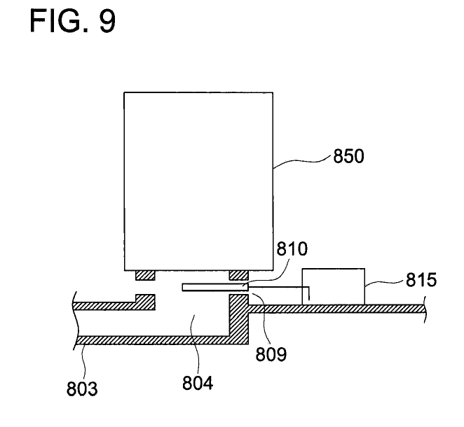

The following describes the structure of modifying the suction force of the suction duct when the control factor has reached the prescribed conditions. FIG. 9 is a schematic diagram of the partial cross section showing the communicating port of FIG. 8. The reference numeral 850 indicates a second suction duct, 803 shows a suction duct formed on the drum frame 8, and 804 represents the communicating port formed on the downstream side of the suction duct 803. The rising portion of the suction duct 803 constituting the communicating port 804 is provided with a slot 809 having an appropriate size. The reference numeral 810 indicates a plate-formed shielding member and is provided movably through the slot 809. The numeral 815 represents a drive device for driving the shielding member 810. In this structure, when the control device S has detected that the control factor has reached a prescribed condition, the drive circuit of the drive device 815 is operated through the control device S, and the drive device 815 moves the shielding member 810 in a straight line, for example, from the first position to the second position.

To put it another way, when the size of the opening of the communicating port 804 has been reduced by the movement of the shielding member 810, the suction force of the suction duct 803 is reduced. When the opening of the communicating port 804 is increased, the suction force of the suction duct is also increased Effective suction and removal in response to the amount of dispersed toner is ensured by proper adjustment of the output utilization rate of the suction device. The shielding member can be moved either by the straight or rotary traveling method, and can be manufactured by considerably free designing.

It is also possible to change the aforementioned method in such a way that the output of the suction device is modified by the electric current control.

As described above, according to the present invention, the suction force of the suction duct is modified based on the result of monitoring the control factors related to toner dispersion amount, whereby an effective suction and removal of the dispersed toner are ensured.

What is claimed is:

1. A dispersed toner removing method for inhaling and removing a dispersed toner occurring in a development area, by forming a suction port of a suction duct in a vicinity of a developer carrying body, and by installing a suction device in a downstream position of a suction route of the suction duct, a toner collecting device being provided between the suction device and the suction duct, and then by operating the suction device at a time of a development process, the dispersed toner removing method comprising the steps of:
monitoring a control factor relating to a toner dispersion amount; and
changing a suction force of the suction duct based on a result of the monitoring of the control factor.

2. The dispersed toner removing method of claim 1
wherein the control factor is a period of use of a carrier which is made of magnetic particles, the magnetic particles and a toner constituting a developer.

3. The dispersed toner removing method of claim 1
wherein the control factor is an ambient relative humidity.

4. The dispersed toner removing method of claim 1
wherein the control factor is a print rate of unit number of prints relating to an amount of a supplied toner per unit number of prints.

5. An image forming apparatus comprising:
an image carrying body;
a developing device for developing an electrostatic latent image formed on the image carrying body, by conveying a developer to a development area by a developer carrying body;
a suction duct having a suction port in a vicinity of the developing device;
a suction device installed in a downstream position of a suction route of the suction duct, a toner collecting device being provided between the suction device and the suction duct; and
a control device which monitors a control factor relating to toner dispersion, and changes and controls a suction force of the suction duct based on a result of the monitoring of the control factor.

6. The image forming apparatus of claim 5,
wherein the developing device is installed detachably and reattachably on a frame for holding the image carrying body, and a part of the suction duct is formed on the frame.
